(19) United States
(12) Patent Application Publication
(10) Pub. No.: US 2019/0379912 A1
(43) Pub. Date: Dec. 12, 2019

(54) HASH TABLE FOR VIDEO AND IMAGE TRANSFORMS

(71) Applicant: GOOGLE LLC, Mountain View, CA (US)

(72) Inventor: Hui Su, Sunnyvale, CA (US)

(21) Appl. No.: 16/002,440

(22) Filed: Jun. 7, 2018

(51) Int. Cl. H04N 19/61; H04N 19/176; H04N 19/124

(52) U.S. Cl. CPC H04N 19/61; H04N 19/124; H04N 19/176

(57) ABSTRACT

A hash table stores records indicative of transform searches performed against prediction residual. A hash value is generated for a prediction residual. The hash value is then checked against records stored in the hash table to determine whether a transform search has already been performed against the prediction residual. In the event a record associated with the hash value is found in the hash table, a transform type and transform size associated with that record is used to transform the prediction residual. Otherwise, a transform search is performed to identify a transform type and transform size to use to transform the prediction residual. The transform type and transform size may be stored in a new record of the hash table alongside the hash value, such as for use in encoding a later block.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

A method for encoding a current block of a video frame according to an implementation of this disclosure comprises generating a prediction residual for the current block. The method further comprises generating a hash value corresponding to the prediction residual. The method further comprises determining whether a hash table includes a record associated with the hash value. The method further comprises, responsive to determining that the hash table includes the record associated with the hash value, identifying a transform type and a transform size associated with the record. The method further comprises generating a transform block by transforming the prediction residual according to the transform type and the transform size. The method further comprises quantizing the transform block to produce a quantized transform block. The method further comprises encoding the quantized transform block to a bitstream.

An apparatus for encoding a current block of a video frame according to an implementation of this disclosure comprises a buffer that stores a hash table and a processor configured to execute instructions stored in a non-transitory storage medium. The instructions include instructions to generate a hash value based on a prediction residual for the current block. The instructions further include instructions to determine whether a hash table includes a record associated with the hash value. The instructions further include instructions to, responsive to a determination that the hash table includes the record associated with the hash value, identify a transform type and a transform size associated with the record. The instructions further include instructions to, responsive to a determination that the hash table does not include the record associated with the hash value, perform a transform search to identify the transform type and the transform size. The instructions further include instructions to generate a transform block by transforming the prediction residual according to the transform type and the transform size. The instructions further include instructions to quantize the transform block to produce a quantized transform block. The instructions further include instructions to encode the quantized transform block to a bitstream.

A method for encoding a current block of a video frame according to an implementation of this disclosure comprises generating a hash value based on a prediction residual for the current block. The method further comprises determining whether a record associated with the hash value is stored in a hash table. The method further comprises, responsive to determining that the record is stored in the hash table, generating a transform block by transforming the prediction residual according to data associated with the record. The method further comprises encoding quantized coefficients of the transform block to a bitstream.

These and other aspects of this disclosure are disclosed in the following detailed description of the implementations, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an example of an encoder.

FIG. 5 is a block diagram of an example of a decoder.

FIG. 6 is a diagram of example of functionality of a transform stage used to transform a prediction residual based on a hash value.

FIG. 7 is a flowchart diagram of an example of a technique for transforming a prediction residual of a current block to encode based on a hash value.

### DETAILED DESCRIPTION

Video compression schemes may include breaking respective images, or frames, into smaller portions, such as blocks, and generating an encoded bitstream using techniques to limit the information included for respective blocks thereof. The encoded bitstream can be decoded to re-create the source images from the limited information. For example, a video compression scheme can include transforming the prediction residual of a current block of a video stream into transform coefficients of transform blocks. The transform coefficients are quantized and entropy coded into an encoded bitstream. A decoder uses the encoded transform coefficients to decode or decompress the encoded bitstream to prepare the video stream for viewing or further processing.

There may be many different transform types and transform sizes available for transforming the prediction residual of a given block. There may be as many as, or even more than, 16 transform types available, such as a discrete cosine transform or an asymmetric discrete sine transform. There may be a varying number of transform sizes available, such as based on the size of the block representing the prediction residual. For example, an 8×8 block representing the prediction residual may be transformed using one 8×8 transform block or four 4×4 transform blocks.

To achieve the best compression efficiency, a typical encoder tries many transform types and transform sizes and selects, for use in transforming the prediction residual, the transform type and transform size combination resulting in a lowest rate-distortion cost. This process is referred to as transform search. However, the transform search can be very time-consuming process, as the number of transform types and sizes may be large. Further, in many cases, the encoder may repeat the transform search process multiple times for the same prediction residual (e.g., where two different prediction modes result in the same prediction, and, therefore, the same prediction residual).

Implementations of this disclosure address problems such as these by using a hash table to store records indicative of transform search. A hash value is generated for a prediction residual. The hash value is then checked against records stored in the hash table to determine whether a transform search has already been performed against the prediction residual. In the event a record associated with the hash value is found in the hash table, a transform type and transform size associated with that record is used to transform the prediction residual. Otherwise, a transform search is performed to identify a transform type and transform size to use to transform the prediction residual. The transform type and transform size may be stored in a new record of the hash table alongside the hash value, such as for use in encoding a later block.

The use of the disclosed hash table prevents repeat transform searches from being performed for the same prediction residual. It may also expedite the encoding process, such as by providing transform type and transform size information to use to transform a prediction residual more quickly than would otherwise be obtained through a transform search.

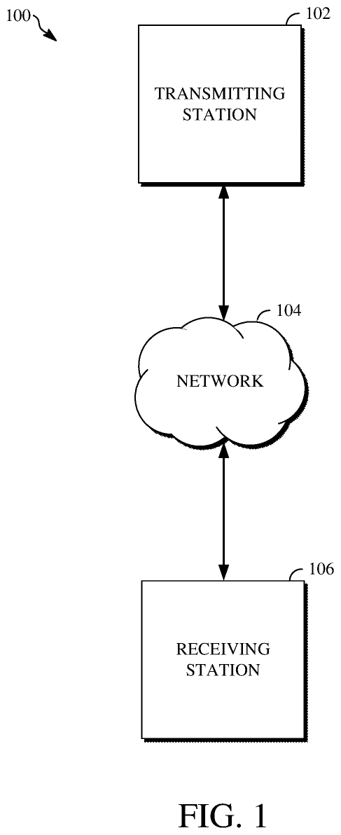

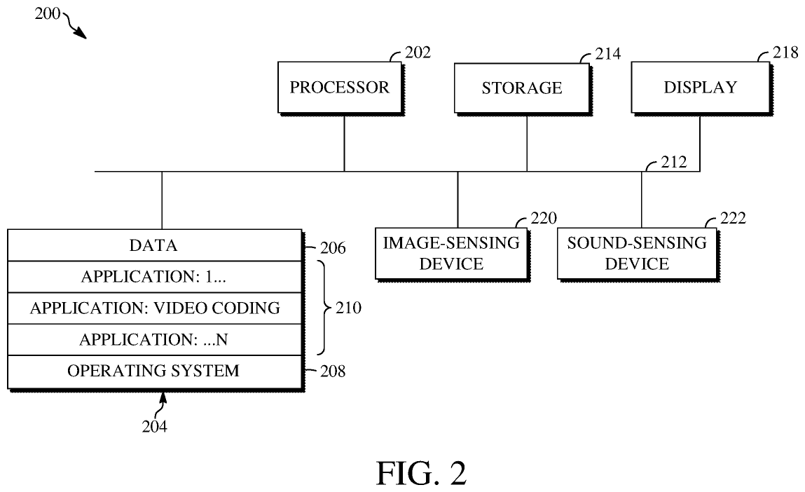

Further details of techniques for transforming prediction residuals based on hash values are described herein with initial reference to a system in which they can be implemented, as shown in FIGS. 1 through 6. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data. Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

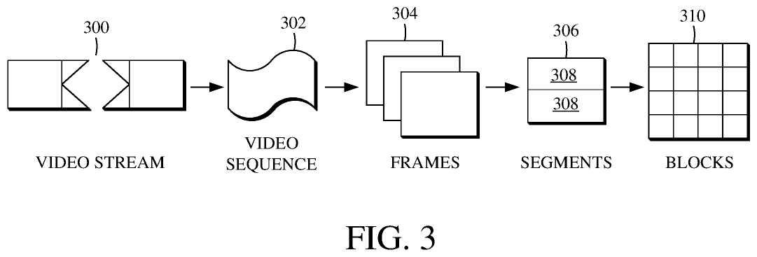

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

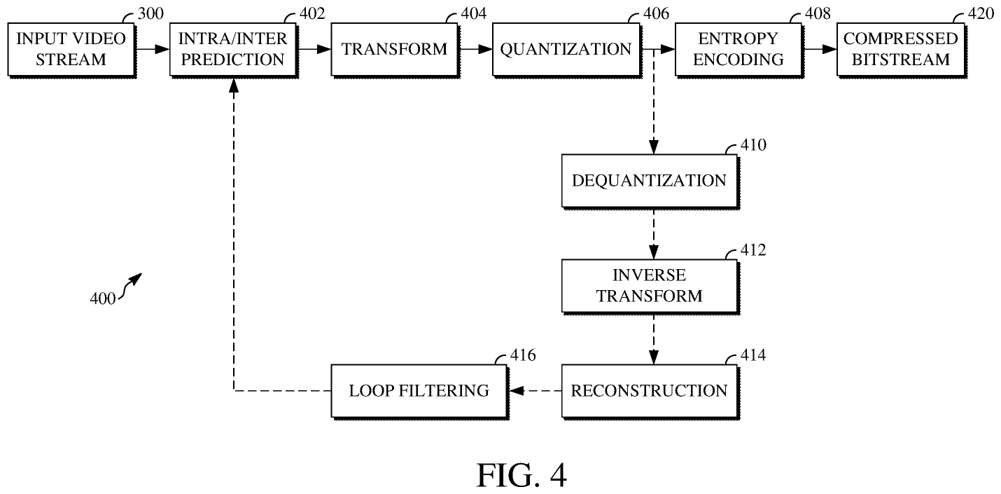

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

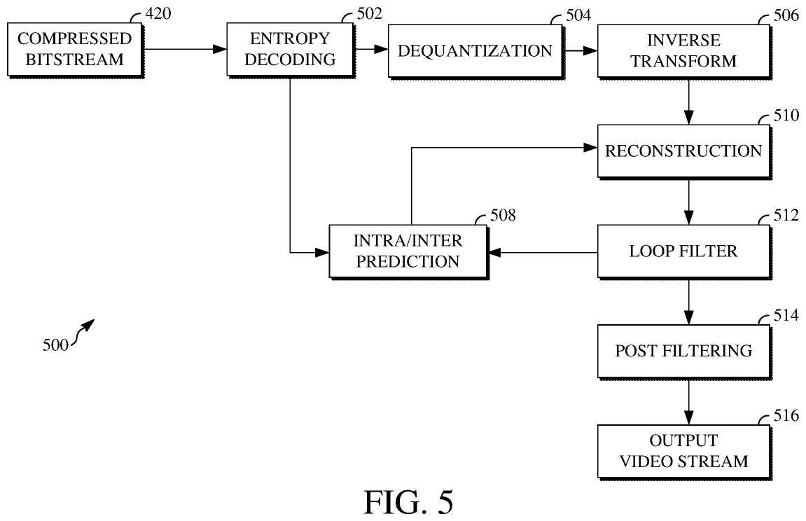

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

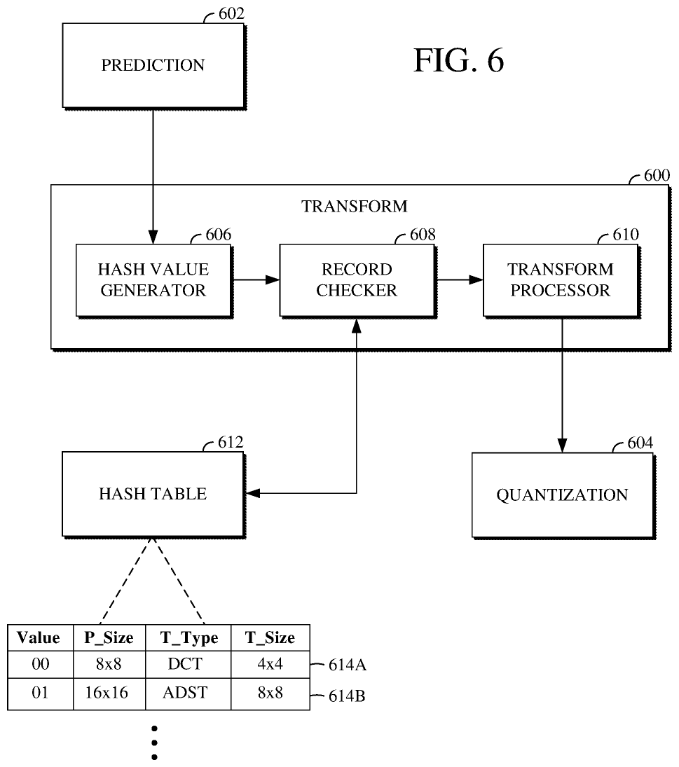

FIG. 6 is a diagram of example of functionality of a transform stage 600 used to transform a prediction residual based on a hash value. The transform stage may, for example, be or include the transform stage 404 shown in FIG. 4. The prediction residual may be a residual generated using a prediction stage 602, which may, for example, be or include the intra/inter prediction stage 402 shown in FIG. 4. After processing the prediction residual, the transform stage 600 outputs the transformed data to a quantization stage 604, which may, for example, be the quantization stage 406 shown in FIG. 4.

The transform stage 600 includes a hash value generator 606, a record checker 608, and a transform processor 610. The hash value generator 606 receives the prediction residual and generates a hash value based on that prediction residual. For example, the hash value generator 606 may use one or more hashing functions (e.g., SHA-1) to generate the hash value by applying a hashing function against the prediction residual. The hash value represents a unique identifier for the prediction residual. The hash value can be mapped to the prediction residual, such as by mapping data which may be generated and/or stored in connection with the hash value.

The record checker 608 determines whether the hash value generated for the prediction residual by the hash value generator 606 is already stored in a hash table 612. The hash table 612 may store a number of records, such as records 614A and 614B, which reflect information including a hash value, a prediction size for a prediction residual, a transform type to use to transform the prediction residual, and a transform size to use to transform the prediction residual.

The record checker 608 determines whether any of the records 614A, 614B is associated with the hash value generated by the hash value generator 606. For example, the record checker 608 may query the hash table 612 using the hash value. The records of the hash table 612 are stored therein on a macroblock level basis. The hash table 612 is stored locally at a computer or server used to perform the encoding of the video data corresponding to the prediction residual. In the event a determination is made that the hash table 612 includes a record associated with the hash value, some or all of the data of that record may be used to transform the prediction residual.

Alternatively, in the event a determination is made that the hash table 612 does not include a record associated with the hash value, the record checker 608 generates a new record for the hash value and stores the new record within the hash table 612. Where the hash table 612 already stores a maximum number of records (e.g., due to a storage size of a buffer or other data store used to implement the hash table 612), the hash table 612 (e.g., on its own or as caused by a command from the record checker 608) selects one or more records to delete. The new record is then stored in the hash table 612.

The transform processor 610 transforms the prediction residual according to output of the record checker 608. For example, in the event the record checker 608 determines that the hash table 612 includes a record associated with the hash value, the transform processor 610 uses data of that record, such as a transform type and a transform size reflected thereby, to transform the prediction residual. Otherwise, the transform processor 610 performs a transform search to determine an optimal transform type and an optimal transform size to use to transform the prediction residual.

In some implementations, the hash value generator 606 uses the hash table 612 to generate the hash value for the prediction residual. For example, the hash table 612 may include the hashing function or functions to use to generate the hash value. In such an implementation, the hash value generator 606 may represent an interface between the transform stage 600 and the hash table 612.

In some implementations, two or more of the hash value generator 606, the record checker 608, or the transform processor 610 may be combined into a single software mechanism of the transform stage 600. For example, the hash value generator 606 and the record checker 608 may be combined into a single software mechanism that generates a hash value and checks the hash table 612 to determine whether the hash table 612 includes a record associated with that hash value before outputting the data for further processing.

In some implementations, a record of the hash table 612 may include data other than as shown in FIG. 6. For example, the record may omit the prediction size. In another example, the record may include other data associated with the prediction residual.

In some implementations, the transform stage 600 can be used to process data other than video data. For example, the transform stage 600 can be used to process image data. The image data may include a block of data from an image. In such an implementation, the prediction stage 602 may be omitted. The transform operations may thus be performed on the image data rather than predicted video data.

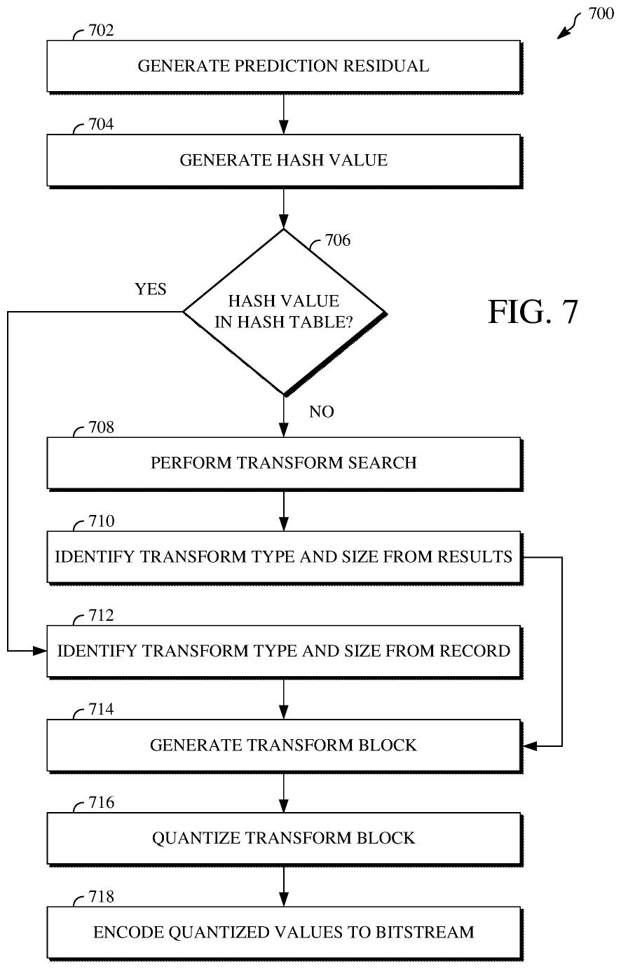

A technique for transforming prediction residuals based on hash values is now described with respect to FIG. 7. FIG. 7 is a flowchart diagram of an example of a technique 700 for transforming a prediction residual of a current block to encode based on a hash value. The technique 700 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 700. The technique 700 can be implemented using specialized hardware or firmware. For example, a hardware component configured to perform the technique 700. As explained above, some computing devices may have multiple memories or processors, and the operations described in the technique 700 can be distributed using multiple processors, memories, or both.

For simplicity of explanation, the technique described with respect to FIG. 7 is depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 702, a prediction residual is generated for the current block. Generating the prediction residual includes performing intra/inter prediction against the current block to generate a prediction block and then determining the difference between the current block and the prediction block. For example, the prediction residual can be generated using the intra/inter prediction stage 402 shown in FIG. 4.

At 704, a hash value corresponding to the prediction residual is generated. The hash value can be generated, for example, by using a hashing function to generate a unique identifier for the prediction residual. For example, an array representing a scan order sequence of the pixel values of the prediction residual can be hashed using a hash function to generate the hash value. In another example, the sum of those pixel values can be hashed using a hash function to generate the hash value.

At 706, a determination is made as to whether a hash table includes a record associated with the hash value. The hash table is a table of a buffer (e.g., a circular buffer) or other data store available to the encoder performing the technique 700. Determining whether the hash table includes a record associated with the hash value includes determining whether a record in the hash table reflects the hash value. For example, a record in the hash table may reflect a row of data in which one piece of the data reflects a hash value and the remaining pieces reflect information about the prediction residual for which the hash value was generated and/or information about how to transform the prediction residual (e.g., an optimal transform size, transform type, or both). Determining whether a record reflects the hash value can include querying the hash table based on the hash value.

At 708, responsive to determining that the hash table does not include a record associated with the hash value, a transform search is performed against the prediction residual. Performing the transform search includes determining rate-distortion values resulting from transforming the prediction residual using different candidate combinations of transform types and transform sizes. The one of the candidate combinations resulting in a lowest one of the rate-distortion values can then be selected.

At 710, a transform type and transform size to use to transform the prediction residual are identified based on the results of the transform search. For example, the transform type and the transform size of the candidate combination selected from the transform search can be identified as the transform type and transform size to use for transforming the prediction residual. Alternatively, at 712, responsive to determining that the hash table includes a record associated with the hash value, the transform type and transform size to use for transforming the prediction residual are identified based on the record.

At 714, a transform block is generated by transforming the prediction residual according to the transform type and the transform size. For example, where the hash table was determined to include the record associated with the hash value, the transform block can be generated by transforming the prediction residual using the information associated with that record. In another example, where the hash table was determined to not include the record associated with the hash value, the transform block can be generated by transforming the prediction residual using the information resulting from the transform search. At 716, the transform block is quantized to produce a quantized transform block. At 718, the quantized transform block is encoded to a bitstream.

In some implementations, the technique 700 can include storing a new record within the hash table. For example, responsive to determining that the hash table does not include a record associated with the hash value, a new record can be stored in the hash table. The new record can, for example, include the hash value and data indicative of the transform type and transform size identified based on the results of the transform search. In some implementations, prior to storing a new record within the hash table, the technique 700 can include checking for a number of records currently stored within the hash table.

For example, the technique 700 can include determining that the hash table includes a maximum number of records. Responsive to that determination, at least one record can be deleted from the hash table, such as according to a deletion policy for the hash table. The deletion policy may, for example, be a least recently used policy, a circular buffer storage policy, or another eviction policy. The new record can be stored in the hash table subsequent to a prior record being deleted therefrom.

In some implementations, the technique 700 can be used to process data other than video data. For example, the technique 700 can be used to process image data. The image data may include a block of data from an image. In such an implementation, the technique 700 may omit operations for generating the prediction residual. The transform operations may thus be performed on the image data rather than predicted video data.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

1. A method for encoding a current block of a video frame, the method comprising:
generating a prediction residual for the current block;
generating a hash value corresponding to the prediction residual;
determining whether a hash table includes a record associated with the hash value;
responsive to determining that the hash table includes the record associated with the hash value, identifying a transform type and a transform size associated with the record;
generating a transform block by transforming the prediction residual according to the transform type and the transform size;
quantizing the transform block to produce a quantized transform block; and
encoding the quantized transform block to a bitstream.

2. The method of claim 1, wherein the transform type is a first transform type and the transform size is a first transform size, the method further comprising:
responsive to determining that the hash value is not included in the hash table, performing a transform search against the prediction residual;
identifying, based on results of the transform search, a second transform type and a second transform size to use to encode the prediction residual; and
generating the transform block by transforming the prediction residual according to the second transform type and the second transform size.

3. The method of claim 2, further comprising:
storing a new record within the hash table, the new record including the hash value and data indicative of the second transform type and the second transform size.

4. The method of claim 3, further comprising:
prior to storing the new record within the hash table, determining that the hash table includes a maximum number of records; and
responsive to determining that the hash table includes the maximum number of records, deleting at least one record from the hash table according to a deletion policy for the hash table.

5. The method of claim 2, wherein performing the transform search against the prediction residual comprises:
determining rate-distortion values resulting from transforming the prediction residual using different candidate combinations of transform types and transform sizes.

6. The method of claim 5, wherein identifying the second transform type and the second transform size to use to encode the prediction residual comprises:
selecting, as the second transform type and the second transform size, the one of the candidate combinations resulting in a lowest one of the rate-distortion values.

7. The method of claim 1, wherein generating the hash value corresponding to the prediction residual comprises:
using a hashing function to generate a unique identifier for the prediction residual.

8. The method of claim 1, wherein the hash table is implemented using a circular buffer.

9. An apparatus for encoding a current block of a video frame, the apparatus comprising:
a buffer that stores a hash table; and
a processor configured to execute instructions stored in a non-transitory storage medium to:
generate a hash value based on a prediction residual for the current block;
determine whether a hash table includes a record associated with the hash value;
responsive to a determination that the hash table includes the record associated with the hash value, identify a transform type and a transform size associated with the record;
responsive to a determination that the hash table does not include the record associated with the hash value, perform a transform search to identify the transform type and the transform size;
generate a transform block by transforming the prediction residual according to the transform type and the transform size;
quantize the transform block to produce a quantized transform block; and
encode the quantized transform block to a bitstream.

10. The apparatus of claim 9, wherein the instructions include instructions to:
subsequent to the transform search, store a new record within the hash table, the new record including the hash value and data indicative of the transform type and the transform size.

11. The apparatus of claim 10, wherein the instructions include instructions to:
prior to storing the new record within the hash table, determining that the hash table includes a maximum number of records; and
responsive to determining that the hash table includes the maximum number of records, deleting at least one record from the hash table according to a deletion policy for the buffer.

12. The apparatus of claim 9, wherein the instructions to perform the transform search to identify the transform type and the transform size include instructions to:
determine rate-distortion values resulting from transforming the prediction residual using different candidate combinations of transform types and transform sizes; and
select, as the transform type and the transform size, the one of the candidate combinations resulting in a lowest one of the rate-distortion values.

13. The apparatus of claim 9, wherein the instructions to generate the hash value based on the prediction residual include instructions to:
use a hashing function to generate a unique identifier for the prediction residual.

14. The apparatus of claim 9, wherein the buffer is a circular buffer.

15. A method for encoding a current block of a video frame, the method comprising:
generating a hash value based on a prediction residual for the current block;
determining whether a record associated with the hash value is stored in a hash table;
responsive to determining that the record is stored in the hash table, generating a transform block by transforming the prediction residual according to data associated with the record; and
encoding quantized coefficients of the transform block to a bitstream.

16. The method of claim 15, wherein the data associated with the record includes a transform type and a transform size, wherein generating the transform block by transforming the prediction residual according to the data associated with the record comprises:
generating the transform block by transforming the prediction residual according to the transform type and the transform size.

17. The method of claim 15, further comprising:
responsive to determining that the record is not stored in the hash table, performing a transform search against the prediction residual to identify a transform type and a transform size to use for encoding the prediction residual; and
generating the transform block by transforming the prediction residual according to the transform type and the transform size.

18. The method of claim 17, further comprising:
storing a new record within the hash table, the new record including the hash value and data indicative of the transform type and the transform size.

19. The method of claim 18, further comprising:
prior to storing the new record within the hash table, determining that the hash table includes a maximum number of records; and
responsive to determining that the hash table includes the maximum number of records, deleting at least one record from the hash table according to a deletion policy for the hash table.

20. The method of claim 17, wherein performing the transform search against the prediction residual to identify the transform type and the transform size to use for encoding the prediction residual comprises:
determining rate-distortion values resulting from transforming the prediction residual using different candidate combinations of transform types and transform sizes; and
selecting, as the transform type and the transform size, the one of the candidate combinations resulting in a lowest one of the rate-distortion values.
